(19) United States
(12) Patent Application Publication
(10) Pub. No.: US 2019/0077253 A1
(43) Pub. Date: Mar. 14, 2019

(54) STORAGE CONTAINER

(71) Applicant: MAGNA STEYR Fuel Systems GesmbH, Sinabelkirchen (AT)

(72) Inventors: Joerg GROSS, Wesseling (DE); Bernd KAHLER, Graz (AT); Kai MAREK, Sebersdorf (AT); Andreas REHERMANN, Korschenbroich (DE)

(21) Appl. No.: 16/119,920

(22) Filed: Aug. 31, 2018

(30) Foreign Application Priority Data
Sep. 12, 2017 (EP) 17190604.3

(51) Int. Cl. B60K 15/077; B60K 15/03

(52) U.S. Cl. CPC B60K 15/077; B60K 15/03; B60K 2015/03032; B60K 2015/0344; B60K 2015/03427; B60K 2015/0777

(57) ABSTRACT

A motor vehicle storage tank includes a tank wall having an inner tank wall and an outer tank wall which collectively define a closed interior space to receive a liquid, at least one baffle arranged in the closed interior space, and a heating element integrated in the baffle to heat the liquid received in the closed interior space.

### CROSS-REFERENCE TO RELATED APPLICATIONS

The present application claims priority 35 U.S.C. § 119 to European Patent Publication No. EP 17190604.3 (filed on Sep. 12, 2017), which is hereby incorporated by reference in its entirety.

### TECHNICAL FIELD

The present invention relates to a storage tank for liquids.

### BACKGROUND

Storage tanks for liquids may comprise a baffle in the known manner. Storage tanks which comprise baffles are used, for example, as tanks for fuel or for different liquid additives in motor vehicles. Movement of a driven vehicle may lead to the liquid sloshing around in the storage tank. Such sloshing around of the liquid may be reduced by baffles.

It is further known that heaters may be installed in storage tanks in order to heat the stored liquid. For example, heaters are used for liquid additives for the post-treatment of exhaust gases. Thus, for example, German Patent Publication No. DE 10 2014 107 519 A1 discloses a heater for a device for providing a liquid additive in a motor vehicle, comprising at least one switchable resistance heating element.

Electrical heating elements are generally arranged on the tank wall and/or on the tank floor in the interior of the storage tank. Electrical cables generally then are to be passed via bores through the tank wall. The bores are to be correspondingly sealed.

### SUMMARY

Embodiments relate to a storage tank for liquids, and particularly, such a storage tank for use in a motor vehicle. The storage tank is heatable and may be produced in a simple and cost-effective manner.

In accordance with embodiments, a motor vehicle storage tank, comprises: tank wall which define an interior space in which a liquid is to be received; at least one baffle to extend in the interior space; and an electrical heating element, integrated in the baffle, to heat the liquid in the interior space.

The storage tank in accordance with embodiments includes a baffle to reduce undesired “sloshing around” of the liquid, i.e., subsequent movements of the liquid in the interior space of the tank when the motor vehicle is being driven/moving. Baffles constitute an obstruction to the movement of the liquid, in particular, by partially forming partitions. At the same time, in principle, such baffles also permit a delayed throughflow of liquid through these partitions, in particular, by the provision of through-openings. Thus a baffle may, in particular, be a partition having through-openings.

Such a baffle, in accordance with embodiments, is used to receive an electrical heating element. As a result, the baffle fulfils a dual purpose and the space available is better utilized. The baffle may also be equally used as a thermally conductive element, so that an enhanced introduction of heat into the liquid may be achieved. Additionally, an electrical connection of the heating element is simplified, since such a connection may be achieved via the baffle and/or via the tank wall connected to the baffle.

The electrical heating element in accordance with embodiments may also comprise regions which protrude from the baffle and which are not located inside the structural wall of the baffle. Embodiments, however, may include a baffle in which the entire heating element is arranged therein.

The storage tank and the baffle in accordance with embodiments may be produced particularly advantageously using an injection-moulding method.

In accordance with embodiments, an electrical connection for the heating element is to be passed from a region outside the structure of the tank, through the tank wall, and terminate in the baffle.

In accordance with embodiments, the electrical connection for the heating element is at least partially encapsulated by injection-moulding via the tank wall. The tank wall may comprise an upper tank wall section and a lower tank wall section. The electrical connection may then be injection-moulded therewith in the upper tank wall section and/or in the lower tank wall section.

Alternatively, or additionally, the electrical connection may be inserted from outside into the baffle and subsequently sealingly welded.

Alternatively, or additionally, the electrical connection for the heating element may comprise a connection plug on the outside of the tank wall, in particular, on the upper tank wall section, such that the connection plug is encapsulated by injection-moulding via the tank wall, in particular the upper tank wall section.

Alternatively, or additionally, the baffle in accordance with embodiments may be composed, at least partially (i.e., at an area in close proximity to the heating element) of a thermally conductive material. Such a thermally conductive material may have a thermal conductivity that is greater than that of the tank material.

Alternatively, or additionally, the baffle may be composed of, at least partially, the same material as the tank wall.

Alternatively, or additionally, the baffle may be produced as a composite of a good thermally conductive material and the material of the tank wall, in particular, using a two-component injection-moulding process.

Alternatively, or additionally, the electrical heating element may comprise a heating mat which is embedded in the baffle.

In accordance with embodiments, during the course of the production of the tank wall and the baffle, the electrical heating element, and particularly, the heating mat, may be injection-moulded therein and therewith in the injection-moulding process.

Alternatively, or additionally, the heating element, in particular, the heating mat, may also be inserted into a double-walled baffle.

### DRAWINGS

Embodiments will be illustrated by way of example in the drawing and explained in the description below.

FIG. 1 illustrates a schematic sectional view of a storage tank, in accordance with embodiments.

### DESCRIPTION

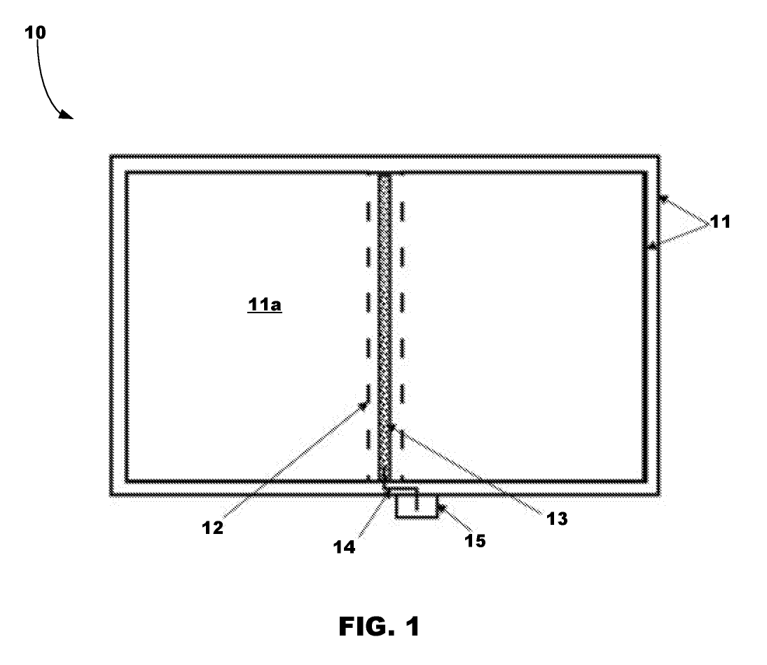

As illustrated in FIG. 1, a storage tank 10 for liquids comprises a tank wall 11 that defines a closed interior space 11a to receive the liquid. The tank wall 11 may comprise an outer tank wall and an inner tank wall. The tank wall 11 may be composed, for example, of a plastic material.

Moreover, in the closed interior space 11a of the storage tank 10 is arranged at least one baffle 12 which in the example shown is arranged vertically in the storage tank in the installation direction. The baffle 12 substantially forms a partition having through-openings for flow of the liquid therethrough. The baffle 12 is, therefore, a two-dimensional planar component.

The storage tank 10 additionally comprises an electrical heating element 13 to heat the liquid in the closed interior space 11a of the storage tank 10. The heating element 13 may comprise a heating mat. The electrical heating element 13 may be integrated into the structure of the baffle 12 so as to be covered by the structural walls of the baffle 12. The baffle 12 may be composed of a composite material having good thermally conductivity. The baffle 12 may be composed of the same material as the tank wall 11, in particular, in a two-component injection-moulding method.

During the course of the production of the tank wall 11 and the baffle 12, the electrical heating element 13 may be injection-moulded therein and therewith or inserted from outside into the baffle 12 and subsequently sealingly welded therein.

An electrical connection 14 for the electrical heating element 13 is passed from outside the tank through the tank wall 11, particularly, through the outer tank wall, the inner tank wall, and into the baffle 12. The electrical connection 14 for the electrical heating element 13 may be partially encapsulated by injection-moulding via the tank wall 11. The electrical connection 14 for the electrical heating element 13 may comprise a connection plug 15 arranged on the outer tank wall of the tank wall 11, which may also be encapsulated by injection-moulding via the tank wall 11.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second, etc. are used herein only to facilitate discussion, and carry no particular temporal or chronological significance unless otherwise indicated.

This written description uses examples to disclose the invention, including the preferred embodiments, and also to enable any person skilled in the art to practice the invention, including making and using any devices or systems and performing any incorporated methods. The patentable scope of embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, may be mixed and matched by one of ordinary skill in the art to construct additional embodiments and techniques in accordance with principles of this application.

### LIST OF REFERENCE SIGNS

10 Storage tank
11 Tank wall
12 Baffle
13 Electrical heating element
14 Electrical connection
15 Connection plug

What is claimed is:

1. A motor vehicle storage tank, comprising:
a tank wall that includes an inner tank wall and an outer tank wall which collectively define a closed interior space to receive a liquid;
at least one baffle arranged in the closed interior space; and
a heating element integrated in the baffle to heat the liquid received in the closed interior space.

2. The motor vehicle storage tank of claim 1, further comprising an electrical connector for electrical connection to the heating element, the electrical connection being arranged outside of the tank wall to extend through the inner tank wall and the outer tank wall and into the baffle.

3. The motor vehicle storage tank of claim 1, further comprising an electrical connector for electrical connection to the heating element, the electrical connection being arranged outside of and at least partially encapsulated by the tank wall to extend through the inner tank wall and the outer tank wall and into the baffle.

4. The motor vehicle storage tank of claim 1, further comprising an electrical connector plug for electrical connection to the heating element, the electrical connection being arranged outside of and encapsulated by the tank wall to extend through the inner tank wall and the outer tank wall and into the baffle.

5. The motor vehicle storage tank of claim 1, wherein the baffle is at least partially composed of thermally conductive material.

6. The motor vehicle storage tank of claim 1, wherein the baffle is at least partially composed of the same material as the tank wall.

7. The motor vehicle storage tank of claim 1, wherein the baffle and the tank wall are composed of a same composite thermally conductive injection-moulded material.

8. The motor vehicle storage tank of claim 1, wherein the electrical heating element comprises a heating mat which is embedded in the baffle.

9. A motor vehicle storage tank, comprising:
a tank wall which defines a closed interior space to receive a liquid;
at least one baffle arranged in the closed interior space, the at least one baffle having a heating element integrated therein to heat the liquid received in the closed interior space.

10. The motor vehicle storage tank of claim 9, further comprising an electrical connector for electrical connection to the heating element, the electrical connection being arranged outside of the tank wall to extend through the tank wall and into the baffle.

11. The motor vehicle storage tank of claim 9, further comprising an electrical connector for electrical connection to the heating element, the electrical connection being arranged outside of and at least partially encapsulated by the tank wall to extend through the tank wall and into the baffle.

12. The motor vehicle storage tank of claim 9, further comprising an electrical connector plug for electrical connection to the heating element, the electrical connection being arranged outside of and encapsulated by the tank wall to extend through the tank wall and into the baffle.

13. The motor vehicle storage tank of claim 9, wherein the baffle is at least partially composed of thermally conductive material.

14. The motor vehicle storage tank of claim 9, wherein the baffle is at least partially composed of the same material as the tank wall.

15. The motor vehicle storage tank of claim 9, wherein the baffle and the tank wall are composed of a same composite thermally conductive injection-moulded material.

16. The motor vehicle storage tank of claim 9, wherein the electrical heating element comprises a heating mat which is embedded in the baffle.

17. A method of manufacturing a storage tank for a motor vehicle, the method comprising:
injection moulding a tank wall which defines a closed interior space to receive a liquid, and at least one baffle arranged in the closed interior space, the at least one baffle having an, electrical heating element integrated therein to heat the liquid received in the closed interior space,
wherein, during the injection moulding of the tank wall and the baffle, the electrical heating element is injection-moulded therein and therewith.
